(19) United States
(12) Patent Application Publication
(10) Pub. No.: US 2020/0344641 A1
(43) Pub. Date: Oct. 29, 2020

(54) NETWORK CONFIGURATION USING CELL CONGESTION PREDICTIONS

(71) Applicant: T-Mobile USA, Inc., Bellevue, WA (US)

(72) Inventors: Vijay Veggalam, Parsippany, NJ (US); Travis Paul Bakeman, Maple Valley, WA (US); Gintaras Gaigalas, Prior Lake, MN (US)

(21) Appl. No.: 16/591,474

(22) Filed: Oct. 2, 2019

Related U.S. Application Data
(60) Provisional application No. 62/838,228, filed on Apr. 24, 2019.
(60) Provisional application No. 62/902,244, filed on Sep. 18, 2019.

(51) Int. Cl. H04W 28/02; H04W 28/06; H04W 76/27; H04W 24/08

(52) U.S. Cl. CPC H04W 28/0284; H04W 28/0289; H04W 24/08; H04W 76/27; H04W 28/06

(57) ABSTRACT

A telecommunication network associated with a wireless telecommunication provider can be configured based, at least in part, on one or more predictions of cell congestion. Data that may be utilized in the prediction of congestion is received and/or collected from one or more components. According to some examples, machine learning is utilized to generate the predictions. The prediction of cell congestion may be a prediction of congestion for a particular cell, or a group of cells (e.g., cells that exhibit similar activity may be clustered). In some configurations, cells that have exhibited congestion may be grouped or clustered such that a user may be able to more easily view mitigation solutions attempted in the past to address the congestion. After generating the cell congestion predictions, one or more actions may be taken to mitigate the predicted congestion.

### RELATED APPLICATIONS

This application claims the benefit of priority to provisional U.S. Patent Application Ser. No. 62/838,228, filed on Apr. 24, 2019 and entitled “Network Configuration Using Cell Congestion Predictions”, and also claims the benefit of priority to provisional U.S. Patent Application Ser. No. 62/902,244, filed on Sep. 18, 2019 and entitled “Network Configuration Using Cell Congestion Predictions”, which are both herein incorporated by reference in their entirety.

### BACKGROUND

Modern terrestrial telecommunication systems include heterogeneous mixtures of second, third, fourth generation, and fifth generation (2G, 3G, 4G, and 5G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long-Term Evolution (LTE), including LTE Advanced, and Evolved High-Speed. Packet Access (HSPA+) are examples of 4G telecommunications technologies. Moving forward, telecommunications systems may include fifth generation (5G) cellular-wireless access technologies to provide improved bandwidth and decreased response times to a multitude of devices that may be connected to a network. The traffic generated by these cellular-wireless access technologies continues to increase. To help address this increase in traffic, wireless service providers continue to deploy base stations as well as other types of network equipment. In some cases, however, these wireless networks become congested and the user experience degrades.

### BRIEF DESCRIPTION OF THE DRAWINGS

The detailed description is set forth with reference to the accompanying figures.

FIG. 1 is a block diagram showing an illustrative environment for network configuration using cell congestion predictions in a cellular network.

FIG. 2 is a block diagram showing an illustrative environment for network configuration using cell congestion predictions.

FIG. 3 is a block diagram illustrating a system that includes one or more components for predicting cell congestion and causing one or more actions to be performed within the network based on the prediction.

FIG. 4 illustrates an example graphical user interface that displays data associated with predicting cell congestion.

FIG. 5 is a flow diagram of an example process that includes configuring a network based on cell congestion predictions according to some implementations.

FIG. 6 is a flow diagram of an example process that includes generating cell congestion predictions according to some implementations

### DETAILED DESCRIPTION

Described herein are techniques and systems for network configuration using cell congestion predictions. Using techniques described herein, a network, such as a telecommunication network associated with a wireless service provider, can be configured based, at least in part, on one or more predictions of cell congestion.

As used herein “cell congestion” refers to network congestion that reduces the quality of service (QoS). Cell congestion can degrade the experience for a user as the congestion can reduce the speed and reliability of the service provided by the telecommunication network. For example, telephone calls, or other type of communication sessions (e.g., a data session) can be dropped and/or the providing of services can be slowed. By predicting cell congestion before it occurs; the telecommunication network can be configured automatically and/or manually in advance of a period of congestion.

The predictions of cell congestion can be for one or more types of networks. For example, the predictions may be for LTE congestion (e.g., Mid-Band Frequencies: LTE 2.1 GHz+LTE 1.9 GHz), 5G congestion, and/or other predictions for congestion for some other frequency(s) (e.g., 2.5 GHz). According to some examples, data that may be utilized in the prediction of congestion is received and/or collected from one or more components within the network.

The data may include but not limited to: Average Radio Resource Control (RRC) Connected User Endpoints (UEs) that provides data about the average connected users per hour which may gradually increase as usage in particular area rises; Max RRC Connected users that provides data about the max connected users, the trend is similar to average but sometimes spikes in this value might predict future increase in average RRC Connected UEs; Uplink (UL) Traffic Volume that provides data about uplink traffic volume; Downlink (DL) Traffic Volume that provides data about the downlink traffic volume; VoLTE Calls that provides data about a number of VoLTE calls that may correlate with average (AVG) RRC users; Average UL Throughput that provides data about the average uplink throughput that degrades with increased usage; Average DL Throughput that provides data about the average downlink throughput that degrades with increased usage and usually at a higher rate than uplink; UL Physical Resource Block (PRB) Utilization that provides data about uplink PRB utilization that may correlate with increasing RRC; DL PRB Utilization that provides data about downlink PRB utilization that may correlate with increasing RRC; E-UTRAN Radio Access Bearer (E-RAB) Setup Failures that provides data about E-RAB failures; where increased failures may indicate beginning of congestion, Control Channel Element (CCE) Blocking that provides data about CCE blocking rate, wherein an increased blocking rate might indicate beginning of congestion; Cell bandwidth that provides data about available bandwidth of the cell; Cell inactivity timer that provides data about inactivity of the cell; Cell neighbor list that provides data about neighboring cells; Subscriber growth that provides data about a number of subscribers that may be increasing or decreasing; weather data that provides data about weather for the cell; and the like; Brand Dimensioning (BD) information—ratio of customers using different plans (for example pre-paid vs post-paid) attached to the same physical sector, also it could be used to define amount of users from different service providers) attached to the same physical sector. In some configurations; hardware information can also be utilized for generating cell congestion predictions (e.g., types of radios, antennas, cables, . . . ).

According to some examples, machine learning is utilized to generate the predictions of cell congestion. The machine learning can be supervised and/or unsupervised (e.g., K-Means clustering, Expectation maximization, . . . ). In some examples, as discussed in more detail below, time series forecasting models (e.g., Kalman filtering, State Space Forecasting, ARIMA) that uses time-series data (e.g.; historical data from a past time period) may be utilized to generate predictions of cell congestion. Machine learning can also be used for preprocessing to improve accuracy. Models for dimensionality reduction such as Principal Component Analysis and feature scaling such as Standard Scaling may be utilized to improve the accuracy of predictions. Machine Learning may also be used to scale the solution. Clustering models such as the ones mentioned above can identify groups of cells that have similar patterns and instead of building models for each cell, a model per cluster may be utilized for optimum use of compute resources for Machine Learning

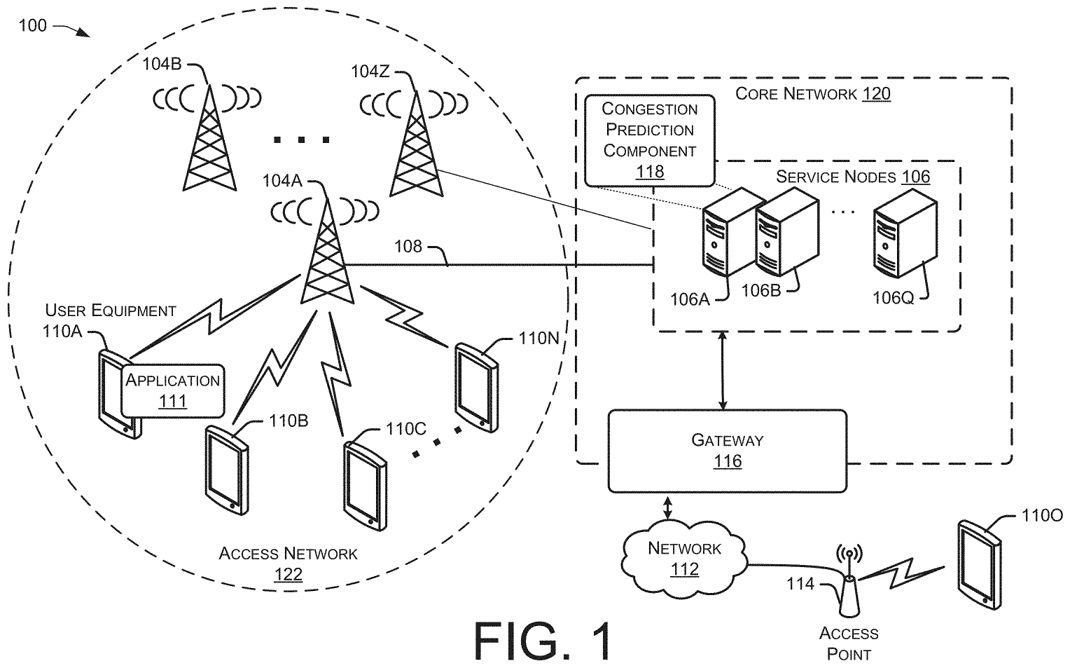

The prediction of cell congestion may be a prediction of congestion for a particular cell, or a group of cells (e.g., cells that exhibit similar activity may be clustered). In some configurations, cells that have exhibited congestion may be grouped or clustered such that a user may be able to more easily view mitigation solutions attempted in the past to address the congestion. According to some configurations, after generating the cell congestion predictions, one or more actions may be taken to mitigate the predicted congestion. For example, a network configuration component may cause one or more actions to be performed within the network (e.g., a self-healing solution may be in a form of a (Self-Organizing Networks) SON component), and the like. In other examples, the cell congestion predictions may be provided to an authorized user for action. More details are provided below with reference to FIGS. 1-6.

FIG. 1 is a block diagram showing an illustrative environment 100 for network configuration using cell congestion predictions in a cellular network. The environment 100 may include a core network 120 and an access network 122 that is associated with a wireless service provider. The environment 100 is illustrated in simplified form and may include many more components.

The environment 100 may include nodes 104, such as nodes 104A 104Z, which may also be referred to herein as “cells”. The nodes 104 may be wireless nodes or wired nodes that are coupled to core network 120 and/or some other network. The environment 100 may also include one or more access points 114, one or more gateways 116, and one or more service nodes 106. A node, such as a node 104 may handle traffic and signals between electronic devices, such as the user equipment 110A 110N, and a core network 120. For example, a node 104 may perform the transcoding of speech channels, allocation of radio channels to electronic devices, paging, transmission and reception of voice and data, as well as other functions. A node 104 may include several base transceiver stations (BTS), each BTS may include a transceiver, antenna, and additional network switch and control equipment that provide a network cell for facilitating wireless communication between UE computing devices and the core network 120. In some examples, the nodes 104 include a gNodeB and/or an eNodeB.

The core network 120 may be responsible for performing functionality relating to predicting cell congestion, routing voice communication to other networks, as well as routing data communication to external packet switched networks, such as the Internet 112. For example, the one or more service nodes 106 may be a Gateway GPRS Support Node (GGSN) or another equivalent node. According to some configurations, the one or more service nodes also include a Policy and Charging Rules Function (PCRF) node that utilized to enforce policy rules of the network. The PCRF node can be configured to automatically make policy decisions for each subscriber (e.g., each user equipment (UE) which may also be referred to herein as “user endpoint”) active on the network. For example, the PCRF may be utilized to allocate bandwidth of the network as well as provide different levels of service to different computing devices on the network. Additionally, some data can be prioritized within the network.

The user equipment 110 are computing devices that can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data using a cellular access network 122, and/or over a Wi-Fi network, or some other type of network. In some instances, the UE 110 computing devices can be configured to send and receive data using any wired or wireless protocols. Additional examples of the UE 110 include, but are not limited to, smart devices such as televisions, music players, or any other electronic appliances that can generate, request, receive, transmit, or exchange voice, video, and/or digital data over a network. The UE 110 can further be configured to establish or receive a communication session, such as a VoLTE, VoNR, VoWifi, or other voice call, a video call, or another sort of communication. Establishment of such sessions can involve communication clients and Session Initiation Protocol (SIP) clients to communicate with the telecommunications network.

In some configurations, one or more of the service nodes 106 may be configured as one or more application servers that provide support for one more applications, such as application 111 utilized by one or more user equipment 110 computing devices. Some example applications include, but are not limited to browser applications, messaging applications, voice applications (e.g., Voice over Internet Protocol “VoIP” applications), video applications, and the like.

While the service nodes 106 are illustrated within the core network 120, one or more other computing devices may be located outside of the core network 120. For example, an application server, or some other server or device, may be connected to the core network 120 via one or more external packet switched networks, such as the Internet. In some examples, one or more computing devices outside of the core network 120 may be utilized to perform processing related to predicting cell congestion for nodes 104 and/or for performing processing relating to network configuration(s) based on the cell congestion predictions.

According to some configurations, a telephony client application, such as application 111, on the UE 110A may establish data communication with the network 120 through a data connection to the node 104A. The node 104A may be a node that routes a communication wired/wirelessly from the UE 110A through the access network 122 for communication to the core network 120.

When a communication request actives at the network 120, one or more of the service nodes 106 may determine the identity of the originating computing device for the communication (e.g., using a telephone number, IMEI, IMSI, IP address) as well as the identity of the computing devices to send the communication. According to some configurations, a UE 110O may connect to the service nodes 106, or some other component such as an application server, via the Internet 112. In such instances, the UE 110E may connect to e Internet 112 via Wi-Fi access point 114. Accordingly, data traffic from the UE 110O may be routed to the service nodes 106 by the gateway 116 of the network 120.

In some configurations, a wireless service provider may utilize alternative access vendor (AAV) networks, for example, which utilize Ethernet networks to provide a wired connection, such as wired connection 108, to provide at least a portion of backhaul for broadband cellular services, such as 5G networks. In other examples, the wireless service provider may deploy its own wired connections.

In general, a node 104 can be implemented as a variety of technologies to provide wired and/or wireless access to the network, as discussed herein. In some instances, the nodes 104 can include a 3GPP RAN, such a GSM/EDGE RAN (GERAN), a Universal Terrestrial RAN (UTRAN), an evolved UTRAN (E-UTRAN), or a New Radio (5G) RAN, or alternatively, a “non-3GPP” RAN, such as a Wi-Fi RAN, or another type of wireless local area network (WLAN) that is based on the IF EE 802.11 standards. Further, the nodes 104 can include any number and type of transceivers and/or base stations representing any number and type of macrocells, microcells, picocells, or femtocells, for example, with any type or amount of overlapping coverage or mutually exclusive coverage. The nodes 104 can be associated with access network 122.

As shown in FIG. 1, some nodes 104 have no physical (i.e., “wired”) data connection to network. In other words, some of the nodes, such as node 10413, are not connected to the core network 120 using fiber cabling, copper cabling, and/or some other type of wired connection. The nodes 104 that do not have a wired connection may be connected to one or more wired nodes 104, such as node 104A, that does have a wired connection to the core network 120. A wired node utilizes fiber, or other wired data connections, to connect to the core network 120. As shown, wired node 104A connects to the core network via an Ethernet connection 108 via a fiber optic, coaxial, or other high speed wired data connection. A wired node 104, such as node 104A, could also be connected by a coaxial, T1, T3, or other suitable high-speed connection to the core network 120.

In some configurations, mesh networking technology can be used to connect different nodes 104 within the access network 122. Geographic Information Services (GIS) and other terrain and location information systems can be used to determine nodes to provide a connection between one or more non-wired nodes and a network 120.

In some instances, the environment 100 can further include one or more servers, including service nodes 106, to facilitate communications by and between the various devices in the environment 100 and perform operations relating to predicting cell congestion (e.g., congestion predictions for nodes 104A-104Z). That is, environment 100 can include any computing devices implementing various aspects of one or more of second, third, fourth generation, and fifth generation (2G, 3G, 4G, and 5G) cellular-wireless access technologies, which may be cross-compatible and may operate collectively to provide data communication services. Global Systems for Mobile (GSM) is an example of 2G telecommunications technologies; Universal Mobile Telecommunications System (UMTS) is an example of 3G telecommunications technologies; and Long-Term Evolution (LTE), including LTE Advanced, Evolved High-Speed Packet Access (HSPA+) are examples of 4G, and 5G NR is an example of 5G telecommunications technologies. Thus, the environment 100 may implement GSM, UMTS, LTE/LTE Advanced, and/or 5G NR telecommunications technologies.

The environment 100 may include, but is not limited to, a combination of: base transceiver stations BTSs (e.g., NodeBs, Enhanced-NodeBs, gNodeBs), Radio Network Controllers (RNCs), serving GPRS support nodes (SGSNs), gateway GPRS support nodes (GGSNs), proxies, a mobile switching center (MSC), a mobility management entity (MME); a serving gateway (SGW), a packet data network (PDN) gateway (PGW), an evolved packet data gateway (e-PDG), an Internet Protocol (IP) Multimedia Subsystem (IMS), or any other data traffic control entity configured to communicate and/or route data packets between the UE 110, the nodes 104; and one or more endpoints of the network (e.g., service nodes 106A-106Q, websites, etc.). While FIG. 1 illustrates an example environment 100, it is understood in the context of this document, that the techniques discussed herein may also be implemented in other networking technologies.

The access network 122 can be any sort of access network, such as a GSM or UMTS network. The access network 122 can include any aspects of one or more of second; third, fourth generation; and fifth generation (2G; 3G, 4G, and 5G) cellular-wireless access technologies. The access network 122 can also be referred to as a universal terrestrial radio network (UTRAN) or a GSM EDGE radio access network (GERAN) and can include one or base stations, as well as a radio network controller (RNC).

As briefly discussed above, a network, such as an access network 122 associated with a wireless telecommunication service provider, can be configured based, at least in part, on one or more predictions of cell congestion. The reduction in the QoS occurs when a network node, such as node 104A, is carrying more data than it can handle. Cell congestion can reduce the speed and reliability of the service provided by network.

In the example illustrated in FIG. 1, the UE 110A initially connects to node 104A at a time when no other UEs 110 are connected. Initially, the user of UE 110 has a good user experience and experiences a high level of QoS as there is no cell congestion. As time progresses, however, other UEs 110, such as UE 110B, and UEs 110C-110N connect to node 104A. As more and more UEs 110 connect to node 104A, or more data or services are used by the already connected UEs 110, the less resources may be allocated to UE 110A, as well as the other connected UEs 110B-110N. At some point, the node 104A will become congested.

When node 104A is experiencing cell congestion, the QoS may be poor and the user experience may not be good. Utilizing techniques described herein, however, the access network 122 may be configured in advance of the period of congestion that is predicted for one or more nodes, such as node 104A. As illustrated, one or more computing devices, such as service node 106A may execute a congestion prediction component 118 that predicts cell congestion before it occurs.

In the current example, the congestion prediction component 118 may predict that node 104A is going to experience cell congestion days/weeks before the activity that may cause the cell congestion even occurs. As briefly discussed above, the predictions of cell congestion can be for one or more types of networks. For example, the predictions may be for LTE congestion (e.g., Mid-Band Frequencies: LTE 2.1 GHz+LTE 1.9 GHz), 5G congestion, and/or other predictions for congestion for some other frequency(s) (e.g., 2.5 GHz).

According to some configurations, the congestion prediction component 118 utilizes historical data (e.g., time-series data that is obtained over a period of time such as a week, a month, or some other range) associated with the operation of nodes 104 to predict future cell congestion. For example, as discussed above, the data may include but is not limited to average RRC connected UEs, max RRC connected users Lit traffic volume, DL traffic volume, VoLTE calls, average RRC users, average UL, throughput, average DL throughput, UL PRB utilization, DL PRB utilization, E-RAB setup failures, CCE blocking, cell bandwidth, cell inactivity timer, cell neighbor list, subscriber growth, and the like. In some configurations, hardware information can also be utilized for the predictions (e.g., types of radios, antennas, cables, . . . ). This data may be collected at the nodes 104 and/or by some other monitoring component.

According to some examples, the historical data that is utilized by the congestion prediction component 118 may be associated with single cells, e.g., node 104A, node 104B, or associated with more than one cell. In some configurations, cells that exhibit similar characteristics (e.g., similar historical data) may be grouped or “clustered” together. For example, in a very large network, cells may be clustered into groups of 1,000 cells (or some other value) such that a prediction of cell congestion is generated for the clustered groups of cells rather than a single cell. In this way, computing resources utilized to generate the cell congestion predictions are reduced as compared to generating cell congestion predictions for each cell in the network. In some examples, a machine learning mechanism may be utilized to cluster similar nodes 104.

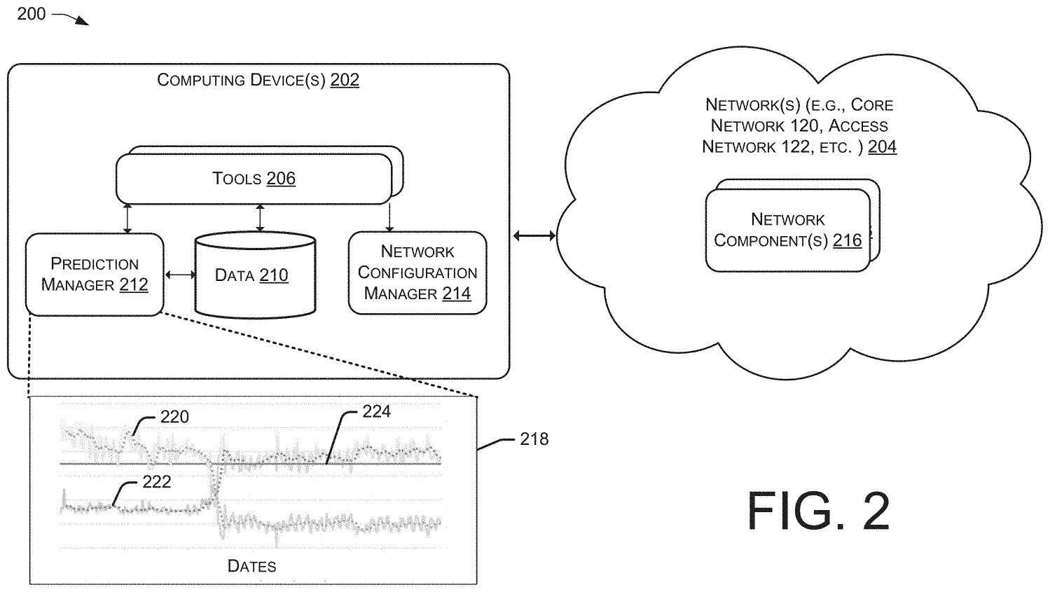

As briefly discussed above, the congestion prediction component 118 utilizes machine learning to generate the predictions of cell congestion and/or cluster similar nodes 104. The machine learning can be supervised and/or unsupervised. In some examples, as discussed in more detail with regard to FIG. 2, the prediction of cell congestion may be based on a Kalman Filtering algorithm.

According to some configurations, after generating the cell congestion predictions for one or more cells or group of cells, one or more actions may be taken to mitigate the predicted congestion. For example, a network configuration component may cause one or more actions to be performed within the network (e.g., a self-healing solution may be in a form of a (Self-Organizing Networks) SON component), and the like. In other examples, the cell congestion predictions may be provided to an authorized user for action. More details are provided below with regard to FIGS. 2-7.

FIG. 2 is a block diagram showing an illustrative environment 200 for network configuration using cell congestion predictions. As illustrated, one or more computing devices 202 associated with one or more networks, such as network(s) 204 may be configured using tools 206. The tools 206 may receive data 210 associated with network information associated with one or more networks, such as access network 122. The tools 206 perform at least one action based on the data 210 and/or data received by the prediction manager 212. For example, the tools 206 may generate updated network configurations and provide the updated network configurations to a network configuration manager 214. The network configuration manager 214 may configure one or more network components 216 of the network 204 by, for example, updating parameters of the network component(s) 216.

In various embodiments, the computing device(s) 202 may each be or include a server or server farm, multiple, distributed server farms, a mainframe, a work station, a personal computer (PC), a laptop computer, a tablet computer, an embedded system, any other sort of device or devices. In one implementation, the computing device(s) 202 represent a plurality of computing devices working in communication, such as a cloud computing network of nodes. The computing device(s) 202 may belong to the network 204 or may be external to but in communication with the network 204. In some configurations, the computing device 202 may be a service node 106.

The network 204 may be any sort of network, such as core network 120 and/or access network 122. In some examples, the network 204 is a self-configuring, self-optimizing, or self-healing network. Self-Organizing Networks (SON) are networks capable of any or all of automatic self-configuration, self-optimization, or self-healing. For radio access networks, such as telecommunication networks, self-configuration may include use of “plug-and-play” techniques for automatically configuring and integrating new base stations into the networks. Self-optimization includes automatic adjustments of node 104 parameters based on cell congestion prediction data generated by the prediction manager 212, the congestion prediction component 118, or some other device or component. Self-healing may also involve automatic adjustments of node 104 parameters. For instance, a neighboring node 104 may be automatically re-configured to support users of a node 104 that is predicted to have cell congestion at some point in the future.

In some examples, the network 204 may be a radio access network, such as a telecommunication access network 122, or some other type of network. The network component(s) 216 of the network 204 may include subnetworks, devices, or components capable of being initialized or configured by the network configuration manager 214 and/or other components. For example, when the network 204 is a telecommunication network, such as a 2G, 3G, 4G/LTE, or 5G network, the network component(s) 216 may be base stations (e.g., Node Bs, &Node Bs, gNode Bs), radio network controllers (RNCs), an operations support system (OSS), a word order system, or other network element(s). Information about the network 204 (referred to herein as “network information”), such as measurements or parameters, may also be provided by the network component(s) 216, or may instead be provided by other sources within the network 204. For example, the network information may be provided by any or all of a trouble ticket system, radio traces, core network traces, from an OSS, or from one or more other network elements. Depending on the purpose(s) of the network 204 (e.g., telecommunications, energy, medical health), the network 204 may include any number of different subnetworks, devices, and components specific to the purpose(s) of the network 204 and may be in communication with any number of devices external to the network 204.

In some embodiments, the prediction manager 212 may be a SON component receives or retrieves network information, such as from congestion prediction component 118 and predicts cell congestion and/or determines modifications to the network 204 based on that network information and/or other data. The prediction manager 212 may have ongoing, periodic, or event-driven connections to sources of network information of the SON 204, and the prediction manager 212 receives or retrieves the network information via those connections.

The prediction manager 212 utilizes data 210, such as historical data associated with one or more key performance indicators, to generate predictions of cell congestion. The data 210 may be any sort of data store, database, file, or data structure. In some examples, the prediction manager utilizes machine learning to determine the data to utilize to generate the predictions of cell congestion. In some embodiments, this may involve filtering out redundant or non-utilized network information.

In some configurations, a machine learning toolkit may be utilized to develop the machine learning mechanisms used to generate the predictions of cell congestion. For example, the ML toolkit may be utilized to configure different parameters (e.g., through a or a guided UI that assists the user in selecting parameters). In some configurations, the prediction manager 212 uses state space forecasting that predicts future values based on data obtained from a specified time (e.g., historical data). According to some examples, the state-space or time-series forecasting may utilize Kalman filters and/or AutoRegressive Integrated Moving Average (ARIMA) algorithms. One or more different forecasting methods may be utilized. Generally, Kalman filter forecasting methods consider subsets of recent data, trend (a slope of line that fits through recent values), and seasonality (repeating patterns). In some examples, a user that is utilizing the prediction manager 212 may specify the future timespan that indicates how far the prediction is to continue (e.g., one week in advance, two weeks, . . . ) in advance of a specified date.

Generally, Kalman filtering, or linear quadratic estimation (LQE), uses time-series data, which may be referred to herein as “historical data” and produces estimates of unknown variables by using Bayesian inference and estimating a joint probability distribution over the variables for different timeframes.

In some configurations, the prediction manager 212 may utilize more than one ML mechanism to generate the predictions for cell congestions. For instance, after generating predictions using a first prediction NIL mechanism that is based on a first set of parameters, data, and algorithms, a different ML mechanism may be utilized that is based on different parameters, data, and algorithms.

In the example as illustrated in FIG. 2, the prediction manager 212 has received data 210 as illustrated in graph 218. Graph 218 includes data 210 that illustrates the average UE DL throughput 220 and the BH average RRC 222. Looking at graph 218, it can be seen that as BH AVG RRC Users 222 increase, the UE DL throughput 220 is affected. When the number of BH AVG RRC users 222 rises above the RRC threshold line 224, the UE DL throughout 220 quickly drops. By performing prediction of cell congestion utilizing the historical data as discussed herein, the congestion of the cell, e.g., node 104A, or some other node 104 predicted to have cell congestion may be eliminated and/or reduced before the congestion occurs. In some examples, the prediction manager 212 may provide the prediction of cell congestion, to an authorized user (e.g., using a UI or some other mechanism) and/or perform one or more adjustments to one or more network components 216 to assist in avoiding the predicted congestion.

In some configurations, the prediction manager 212 automatically provides data (e.g., “cell congestion prediction data”) associated with the predictions to one or more of the tools 206. According to some examples, one or more of the tools 206 may generate an updated network configuration, and/or other data used by network configuration manager 214 to configure the network 204. In some configurations, the tools 206 may perform one or more tasks associated with self-configuration, self-optimization, or self-healing of the network 204.

The updated network configuration may simply be an update to a single parameter of a single network component 216 or may represent a more comprehensive configuration of multiple parameters of multiple network components 216. Examples of tools 206 may include any or all of an automated report generating tool, a parameter consistency check tool, a real-time alert tool, a mobility evaluation tool, a coverage and interference management tool, a network outage tool, a network configuration tool, a load distribution tool, a spectrum carving tool, or a special events tool. Additionally, or instead, the tools 206 may include any or all of a performance management tool, a radio frequency (RF) planning tool, an automatic frequency planning tool, a rehoming tool, an automatic cell planning tool, a geolocation tool, and the like. These tools 206 may be self-contained and perform actions relating to interfacing directly with network components to retrieving measurements and configuring parameters, to smart analysis of and decisions regarding measurements and configurations, to presentation of users of relevant information.

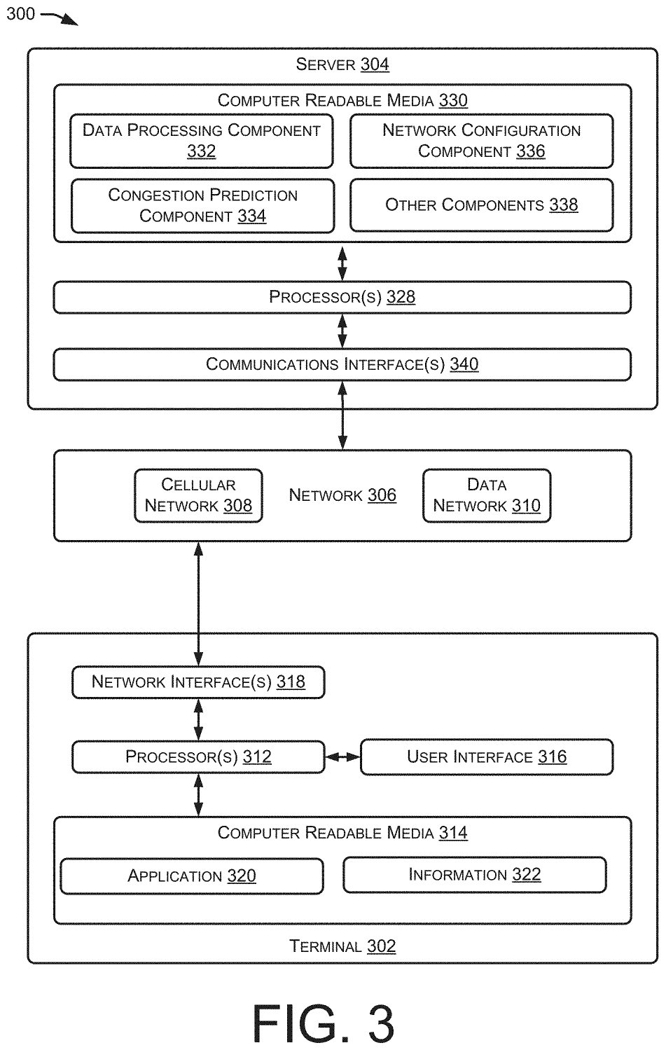

FIG. 3 is a block diagram illustrating a system 300 that includes one or more components for predicting cell congestion and causing one or more actions to be performed within the network base on the prediction according to some implementations. The system 300 includes a terminal 302, which can represent a UE 110, or another computing device, coupled to a server 304, via a network 306. The server 304 can represent a computing device, such as one or more of the servers within the network 120 and/or access network 122, and/or some other computing device. The network 306 can represent network 120 and/or access network 122, or some other network.

The network 306 can include one or more networks, such as a cellular network 308 and a data network 310. The network 306 can include one or more core network(s) connected to terminal(s) via one or more access network(s). Example access networks include LTE, WIFI, GSM Enhanced Data Rates for GSM Evolution (EDGE) Radio Access Network (GERAN), UTRAN, and other cellular access networks. Message transmission, reception, fallback, and deduplication as described herein can be performed, e.g., via 3G, 4G, 5G, WIFI, or other networks.

The cellular network 308 can provide wide-area wireless coverage using a technology such as GSM, Code Division Multiple Access (CDMA), UMTS LTE, NR or the like. Example networks include Time Division Multiple Access (TDMA), Evolution-Data Optimized (EVDO), Advanced LTE (LTE+), Generic Access Network (GAN), Unlicensed Mobile Access (UMA), Orthogonal Frequency Division Multiple Access (OFDM), GPRS, EDGE, Advanced Mobile Phone System (AMPS), High Speed Packet Access (HSPA), evolved HSPA (HSPA+), VoIP, VoLTE, IEEE 802.1x protocols, wireless microwave access (WIMAX), WIFI, and/or any future IP-based network technology or evolution of an existing IP-based network technology. Communications between the server 304 and terminals such as the terminal 302 can additionally or alternatively be performed using other technologies, such as wired (Plain Old Telephone Service, POTS, or PSTN lines), optical (e.g., Synchronous Optical NETwork, SONET) technologies, and the like.

The data network 310 can include various types of networks for transmitting and receiving data (e.g., data packets), including networks using technologies such as WIFI, IEEE 802.15.1 (“BLUETOOTH”), Asynchronous Transfer Mode (ATM), WIMAX, and other network technologies, e.g., configured to transport IP packets. In some examples, the server 304 includes or is communicatively connected with an IWF or other device bridging networks, e.g., LTE, 3G, and POTS networks. In some examples, the server 304 can bridge SS7 traffic from the PSTN into the network 306, e.g., permitting PSTN customers to place calls to cellular customers and vice versa.

In some examples, the cellular network 308 and the data network 310 can carry voice or data. For example, the data network 310 can carry voice traffic using VoIP or other technologies as well as data traffic, or the cellular network 308 can carry data packets using HSPA, LTE, or other technologies as well as voice traffic. Some cellular networks 308 carry both data and voice in a PS format. For example, many LTE networks carry voice traffic in data packets according to the VoLTE standard. Various examples herein provide origination and termination of, e.g., carrier-grade voice calls on, e.g., networks 306 using CS transports or mixed VoLTE/3G transports, or on terminals 302 including OEM handsets and non-OEM handsets.

The terminal 302 can be or include a wireless phone, a wired phone, a tablet computer, a laptop computer, a wristwatch, or other type of terminal. The terminal 302 can include one or more processors 312, e.g., one or more processor devices such as microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs), and one or more computer readable media (CRM) 314, such as memory (e.g., random access memory (RAM), solid state drives (SSDs), or the like), disk drives (e.g., platter-based hard drives), another type of computer-readable media, or any combination thereof. The CRM or other memory of terminal 302 can hold a datastore, e.g., an SQL or NoSQL database, a graph database, a BLOB, or another collection of data. The terminal 302 can further include a user interface (UI) 316, e.g., including an electronic display device, a speaker, a vibration unit, a touchscreen, or other devices for presenting information to a user and receiving commands from the user. The terminal 302 can further include one or more network interface(s) 318 configured to selectively communicate (wired or wirelessly) via the network 306, e.g., via an access network 122.

The CRM 314 can be used to store data and to store instructions that are executable by the processors 312 to perform various functions as described herein. The CRM 314 can store various types of instructions and data, such as an operating system, device drivers, etc. The processor-executable instructions can be executed by the processors 312 to perform the various functions described herein.

The CRM 314 can be or include computer-readable storage media. Computer-readable storage media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, non-transitory medium which can be used to store the desired information and which can be accessed by the processors 312. Tangible computer-readable media can include volatile and nonvolatile, removable and non-removable media implemented in any method or technology for storage of information, such as computer readable instructions, data structures, program components, or other data.

The CRM 314 can include processor-executable instructions of an application 320. The CRM 314 can store information 322 identifying the terminal 302. The information 322 can include, e.g., an IMEI, an IMSI identifying the subscriber using terminal 302, or other information discussed above. The CRM 314 can additionally or alternatively store credentials (omitted for brevity) used for access, e.g., to IMS or RCS services.

The server 304 can include one or more processors 328 and one or more CRM 330. The CRM 330 can be used to store processor-executable instructions of a data processing component 332, a congestion prediction component 334 which may be congestion prediction component 118, a network configuration component 336, as well as one or more other components 338. The processor-executable instructions can be executed by the one or more processors 328 to perform various functions described herein.

In some examples, server 304 can communicate with (e.g., is communicatively connectable with) terminal 302 or other devices via one or more communications interface(s) 340, e.g., network transceivers for wired or wireless networks, or memory interfaces. Example communications interface(s) 340 can include ETHERNET or FIBRE CHANNEL, transceivers, WIFI radios, or DDR memory-bus controllers (e.g., for DMA transfers to a network card installed in a physical server 304).

In some examples, processor 312 and, if required, CRM 314, are referred to for brevity herein as a “control unit.” For example, a control unit can include a CPU or DSP and instructions executable by that CPU or DSP to cause that CPU or DSP to perform functions described herein. Additionally, or alternatively, a control unit can include an ASIC, FPGA, or other logic device(s) wired (physically or via blown fuses or logic-cell configuration data) to perform functions described herein. Other examples of control units can include processor 328 and, if required, CRM 330.

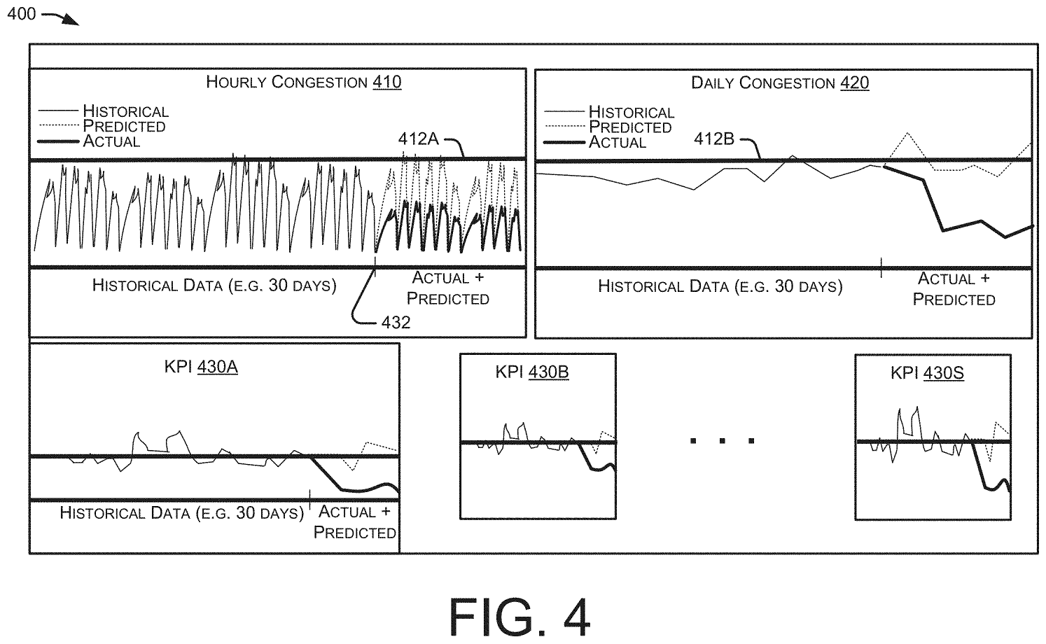

FIG. 4 illustrates an example graphical user interface (GUI) 400 that displays data associated with predicting cell congestion. As illustrated, GUI 400 illustrates different data associated with predicting cell congestion. While certain data is illustrated, other data (e.g., other Key Performance indicators (KPIs)) may be configured for display within GUI 400 or some other GUI, or UI.

The example GUI 400 illustrated in FIG. 4 displays hourly congestion data 410, daily congestion data 420, and KPI data 430A-430S. As shown, the hourly congestion data 410 shows historical data for 30 days, predicted data as indicated by the dashed line, and actual data for a period of time (e.g., seven days). In this way, a user may view the GUI and be able to easily view congestion data (or other KPI data) for a particular cell or a cluster of cells.

As can be by referring to the hourly congestion data 410, the historical data exceeded the threshold hourly congestion line 412A a few times before action was taken to address the congestion. At point 432, the prediction manager 212, the network configuration manager 214, and/or some other component or authorized user configured one or more network components 216 based on the predicted cell congestion. As can be seen, after the configuration, the actual congestion for the cell(s) was reduced.

In some configurations, the user may also view other KPI data to gain a further understanding of how the cell was/is performing. Generally, the user may specify what KPIs to display within GUI 400. In this way, a user can see historical data for one or more KPIs, predicted data for the one or more KPIs, and actual data for the one or more KPIs to provide the user with insights on what actions have been useful in addressing the predicted congestion.

According to some configurations, the GUI 400, or some other UI, may display one or more strategies to mitigate the cell congestion. For example, one strategy may be to add another node 104 to handle additional data. Another strategy might be to offload a portion of the data traffic to WIFI. Yet another strategy might be to suggest one or more changes to manage the data traffic (e.g., cashing, data compression, throttling, . . . ).

### Example Process

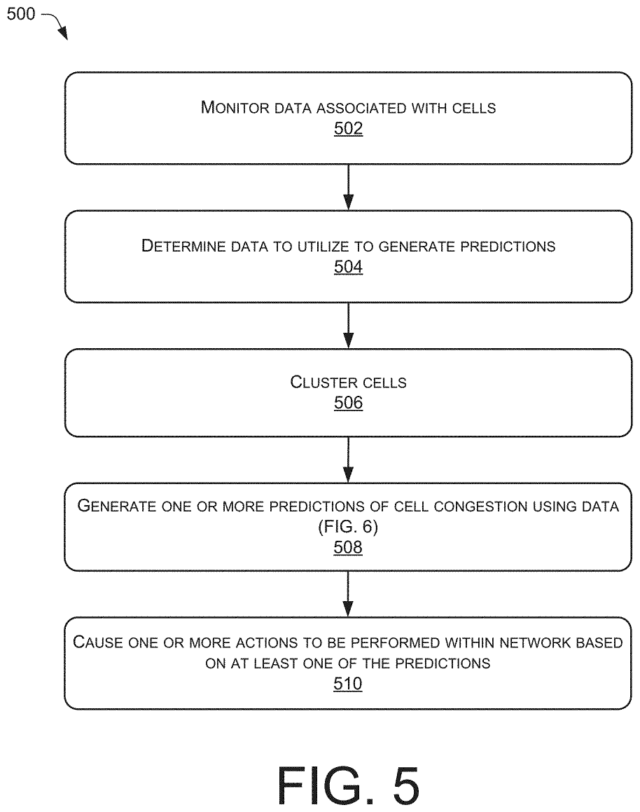

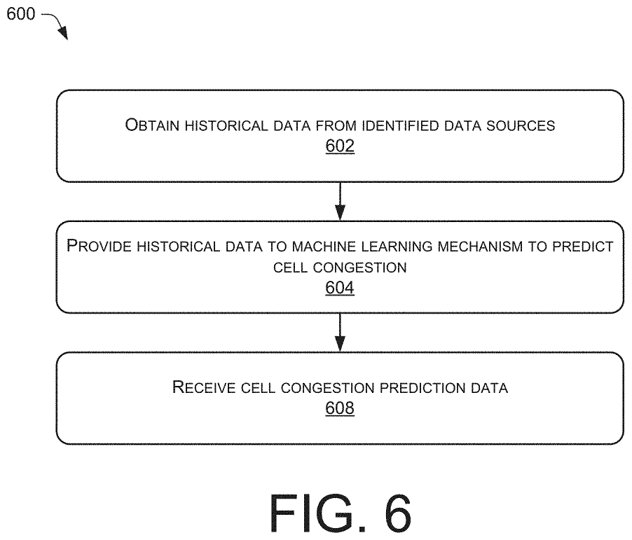

FIG. 5 and FIG. 6 illustrate example processes. Each of these processes are illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 5 illustrates an example process for performing one or more actions based on a prediction of cell congestion. The process includes, at 502, monitoring data, such as one more performance indicators associated with network information as discussed above, and/or Radio Access Network (RAN) cell level counters, RAN cell parameters, weather patterns, seasonality affects, subscription activation per geographical areas, and the like is performed.

At 504, the data to utilize in generating one or more predictions of cell congestion is determined. In some examples, instead of basing the predictions of cell congestion using all of the data received, the predictions of cell congestion can be based on data identified (e.g., by one or more machine learning mechanisms, or some other method) to be an accurate predictor of cell congestion. In this way, the amount of computing resources utilized are less as compared to when all of the data are utilized. For example, the data used to generate the cell congestion prediction data may be based on data such as but not limited to RRC Connected UEs, Kalman CCE Blocking, and the like.

At 506, cells may be clustered. As discussed above, cells that have similar KPI data (e.g., similar RRC data, CCE blocking, . . . ) may be clustered together. Clustering the similar cells can reduce the computational challenges in generating cell congestion predictions for a large number of cells.

At 508, a prediction of cell congestion is generated using the data. As illustrated in FIG. 5, the prediction of cell congestion can be based on all or a portion of the data received at 502. In some examples, one or more machine learning mechanisms are utilized. According to some configurations, as discussed in more detail herein, Kalman filtering that uses time-series data (e.g., historical data from a past time period) may be utilized to generate the predictions of cell congestion. See FIG. 6 and related discussion for more details.

At 510, one or more actions may be performed based, at least in part on the prediction. The actions may include but are not limited to traffic shaping by optimizing various RE parameters, generating an updated network configuration, configuring a network, invoking, via an Application Programming Interface (API) or using some other method, a component or tool to perform an action, and the like.

FIG. 6 illustrates an example process for generating predictions of cell congestion. The process includes, at 602, obtaining historical data, such as data associated with the monitoring of one more performance indicators associated with network information. For example, the performance indicators may be associated with one or more of Radio Access Network (RAN) cell level counters, RAN cell parameters, weather patterns, seasonality affects, subscription activation per geographical areas, and the like. According to some configurations, RRC user data (e.g., hourly average RRC users), CCE blocking (e.g., Kalman hourly CCE Blocking), and/or PRB utilization data (e.g., downlink and/or uplink) historical data is accessed. The historical data may be associated with different time periods (e.g., a week, two weeks, three weeks, a month, and the like). In other examples, data associated with other KPIs may be utilized.

At 604, the historical data is provided to a machine learning mechanism to predict cell congestions. As discussed above, the historical data may be provided to a prediction manager 212, and/or a congestion prediction component 118, and/or some other computing device or component to generate cell congestion prediction data.

At 606, the cell congestion prediction data is received. As discussed above, the cell congestion prediction data may be received from the prediction manager 212, and/or a congestion prediction component 118, and/or some other computing device or component. The cell congestion prediction data may then be utilized to cause one or more actions to be performed within network to help reduce and/or eliminate the predicted cell congestion.

Although the subject matter has been described in language specific to structural features and/or methodological acts, it is to be understood that the subject matter described in this disclosure is not necessarily limited to any of the specific features or acts described. Rather, the specific features and acts are disclosed as examples and embodiments of the present disclosure.

What is claimed is:

1. A system comprising:
one or more processors;
a memory; and
one or more components stored in the memory and executable by the one or more processors to perform operations comprising:
accessing historical data associated with performance of one or more cells of a telecommunication network;
providing at least a portion of the historical data to one or more machine learning mechanism to generate cell congestion prediction data for at least one of the one or more cells; and
causing one or more actions to be performed to reduce a congestion of the at least one of the one or more cells based, at least in part, on the cell congestion prediction data.

2. The system of claim 1, the operations further comprising monitoring one or more performance indicators associated with the one or more cells within the telecommunication network to generate at least a portion of the historical data.

3. The system of claim 2, wherein the monitoring the one or more performance indicators comprises monitoring one or more of a Radio Resource Control (RRC) Connected User Endpoints (UEs) performance indicator, or a Control Channel Element (CCE) Blocking performance indicator.

4. The system of claim 2, wherein providing the at least the portion of the historical data to the one or more machine learning mechanisms comprises providing at least two weeks of the historical data that includes data generated from the monitoring of the one or more performance indicators.

5. The system of claim 1, wherein causing the one or more actions to be performed comprises providing congestion data to a computing device associated with an operator of the telecommunications network, wherein the congestion data identifies the at least one of the one or more cells and one or more strategies to mitigate cell congestion for the at least one of the one or more cells.

6. The system of claim 1, wherein causing the one or more actions to be performed comprises causing one or more components of the telecommunications network to re-configure.

7. A computer-implemented method performed by one or more processors configured with specific instructions, the computer-implemented method comprising:
accessing historical data associated with performance of one or more cells of a telecommunication network;
providing at least a portion of the historical data to one or more machine learning mechanisms to generate cell congestion prediction data for at least one of the one or more cells; and
causing one or more actions to be performed to reduce a congestion of the at least one of the one or more cells based, at least in part, on the cell congestion prediction data.

8. The computer-implemented method of claim 7, further comprising monitoring performance indicators associated with the one or more cells within the telecommunication network to generate at least a portion of the historical data.

9. The computer-implemented method of claim 8, further comprising clustering cells of the telecommunication network into a plurality of clusters based, at least in part, on the monitoring the performance indicators.

10. The computer-implemented method of claim 8, wherein monitoring the performance indicators associated with the one or more cells comprises generating hourly data associated with the performance indicators.

11. The computer-implemented method of claim 8, wherein the monitoring the performance indicators comprises monitoring one or more of: Radio Resource Control (RRC) Connected User Endpoints (UEs), Control Channel Element (CCE) Blocking, Uplink (UL) Traffic Volume, Downlink (DL) Traffic Volume, or Radio Access Bearer (E-RAB) Setup Failures.

12. The computer-implemented method of claim 7, wherein causing the one or more actions to be performed comprises providing congestion data to a computing device associated with an operator of the telecommunications network, wherein the congestion data identifies the at least one of the one or more cells.

13. The computer-implemented method of claim 7, wherein causing the one or more actions to be performed comprises causing one or more components of the telecommunications network to re-configure.

14. A non-transitory computer-readable media storing computer-executable instructions that, when executed, cause one or more processors of a computing device to perform acts comprising:
providing historical data to one or more machine learning mechanisms to generate cell congestion prediction data for cells of a telecommunication network, wherein the historical data is associated with performance of the cells; and
causing one or more actions to be performed to reduce a congestion of one or more of the cells based, at least in part, on the cell congestion prediction data.

15. The non-transitory computer-readable media of claim 14, wherein the acts further comprise monitoring performance indicators associated with the cells to generate least a portion of the historical data.

16. The non-transitory computer-readable media of claim 15, wherein the acts further comprise clustering cells of the telecommunication network into a plurality of clusters based, at least in part, on the monitoring the performance indicators.

17. The non-transitory computer-readable media of claim 15, wherein the monitoring the performance indicators comprises monitoring one or more of: Radio Resource Control (RRC) Connected User Endpoints (UEs), or Control Channel Element (CCE) Blocking.

18. The non-transitory computer-readable media of claim 14, wherein causing the one or more actions to be performed comprises providing congestion data to a computing device associated with an operator of the telecommunications network, wherein the congestion data identifies the at least one of the one or more cells.

19. The non-transitory computer-readable media of claim 14, wherein causing the one or more actions to be performed comprises providing one or more strategies to a computing device associated with an operator of the telecommunications network.

20. The non-transitory computer-readable media of claim 14, wherein causing the one or more actions to be performed comprises causing one or more components of the telecommunications network to re-configure.
